(19) United States
(12) Patent Application Publication
(10) Pub. No.: US 2015/0042658 A1
(43) Pub. Date: Feb. 12, 2015

(54) PROVIDING IMAGE INFORMATION OF AN OBJECT

(71) Applicant: KONINKLIJKE PHILIPS N.V., EINDHOVEN (NL)

(72) Inventors: Klaus Erhard, Hamburg (DE); Andre Goossen, Radbruch (DE); Harald Sepp Heese, Hamburg (DE)

(21) Appl. No.: 14/384,080

(22) PCT Filed: Mar. 5, 2013
(86) PCT No.: PCT/IB2013/051729

§ 371 Date: Sep. 9, 2014

Related U.S. Application Data
(60) Provisional application No. 61/609,491, filed on Mar. 12, 2012.

(51) Int. Cl. G06F 19/00; G06T 5/00; G06T 15/08; G06T 19/20; G06T 11/00

(52) U.S. Cl. CPC G06F 19/321; G06T 19/20; G06T 11/008; G06T 15/08; G06T 5/002; G06F 19/3406; G06T 2207/10124; G06T 2207/30068; G06T 2207/20182; G06T 2219/2008
USPC 345/427

(57) ABSTRACT

The present invention relates to the presentation of image information of an object. In order to provide complex image information in a more effective manner, it is proposed to: a) provide (110) 3D volume data (112) of an object; b) identify (114) candidate findings (116) located in the 3D volume data, wherein spatial position information of the candidate findings is assigned to the respective identified candidate finding; c) generate (118) a plurality of tagged slice images (120) of the 3D volume data, wherein each tagged slice image relates to a respective portion of the 3D volume data, and wherein the tagged slice images comprise those candidate findings identified in the respective portion and a tag with the spatial information of the respective candidate finding within the 3D volume; d) compute (122) a synthetic 2D projection (124) by a forward projection of at least a portion of at least a number of the plurality of tagged slice images, wherein the synthetic 2D projection comprises a projection of the candidate findings, and wherein the spatial position information is assigned to the projection of the candidate finding; and e) present (126) the synthetic 2D projection as a synthetic viewing image (128) to a user, wherein the candidate findings are selectable elements within the synthetic viewing image.

### FIELD OF THE INVENTION

The present invention relates to presentation of medical image information of an object. In particular, the present invention relates to an apparatus for providing medical image information of an object, a graphical user interface, a method for providing medical image information of an object, a computer program element and a computer readable medium.

### BACKGROUND OF THE INVENTION

For example in the medical field, the presentation of complex image information to a radiologist or skilled medical staff is an important fact in terms of supporting the provision of exact appraisal. With the emerging 3D imaging methods such as tomosynthesis and computer aided detection (CAD), more comprehensive and more detailed information becomes available. At the same time, productivity of staff is important to ensure that results of an imaging method or related method can be assessed and interpreted effectively by the medical staff. It has been shown that presenting complex image information requires increased attention on the side of the user. U.S. Pat. No. 7,929,743 describes a method for processing and displaying computer-aided detection results using CAD markers.

### SUMMARY OF THE INVENTION

Hence, there may be a need to provide complex image information perceivable in a more effective manner.

The object of the present invention is solved by the subject-matter of the independent claims, wherein further embodiments are incorporated in the dependent claims.

It should be noted that the following described aspects of the invention also apply for the apparatus for providing medical image information of an object, the graphical user interface, the method, the computer program element and the computer readable medium.

According to a first aspect of the invention, an apparatus is provided for providing image information of an object. The apparatus comprises a data input unit, a processing unit, and a presentation unit. The data input unit is configured to provide 3D volume data of an object. The processing unit is configured to identify candidate findings located in the 3D volume data. The processing unit is configured to assign spatial position information of the candidate findings to the respective identified candidate finding to generate a plurality of tagged slice images of the 3D volume data. Each tagged slice image relates to a respective portion of the 3D volume data. The tagged slice images comprise those candidate findings identified in the respective portion and a tag with the spatial information of the respective candidate finding within the 3D volume. A synthetic 2D projection is computed by a forward projection of the plurality of tagged slice images. The synthetic 2D projection comprises a projection of the candidate findings. The spatial position information is assigned to the projection of the candidate finding. The presentation unit is configured to present the synthetic 2D projection as a synthetic viewing image to a user. The candidate findings are selectable elements within the synthetic viewing image.

According to an exemplary embodiment of the invention, the processing unit is further configured to enhance the candidate findings for the generation of the tagged slice images, which enhancement is visible in the 2D projection.

According to a second aspect of the invention, a graphical user interface is provided for providing image information of an object. The graphical user interface comprises a display unit, a graphical user interface controller, and an input device. The display unit is configured to present a synthetic viewing image based on a synthetic 2D projection generated by a forward projection of at least a portion of at least some of a plurality of tagged slice images of 3D volume data of an object. The tagged slice images comprise identified candidate findings and a tag with spatial information of the respective candidate finding within the 3D volume, and the synthetic viewing image comprises a plurality of interrelated image elements linked to the identified candidate findings. The input device is provided for selecting at least one of the interrelated image elements in the synthetic viewing image presented by the display unit. The graphical user interface controller is configured to provide control signals to the display unit to display spatial information in relation with the at least one selected interrelated image element. The display unit is further configured to update the spatial information depending on the selection of the interrelated image elements.

According to an exemplary embodiment of the invention, the graphical user interface controller is configured to determine at least one of the tagged slice images, in which the candidate finding is located that is linked to the selected at least one interrelated image element. The display unit is configured to display the determined at least one tagged slice image in addition to the synthetic viewing image.

According to a third aspect of the invention, a method for providing image information of an object is provided, the method comprising the following steps:

a) providing 3D volume data of an object;
b) identifying candidate findings located in the 3D volume data; wherein spatial position information of the candidate findings is assigned to the respective identified candidate finding;
c) generating a plurality of tagged slice images of the 3D volume data; wherein each tagged slice image relates to a respective portion of the 3D volume data; and wherein the tagged slice images comprise those candidate findings identified in the respective portion and a tag with the spatial information of the respective candidate finding within the 3D volume;
d) computing a synthetic 2D projection by a forward projection of at least a portion of at least a number of the plurality of tagged slice images; wherein the synthetic 2D projection comprises a projection of the candidate findings; and wherein the spatial position information is assigned to the projection of the candidate finding; and
e) presenting the synthetic 2D projection as a synthetic viewing image to a user; wherein the candidate findings are selectable elements within the synthetic viewing image.

According to an exemplary embodiment of the invention, the synthetic 2D projection is computed by a forward projection of at least a portion of each of the plurality of the tagged slice images.

According to an exemplary embodiment of the invention, for the generation of the tagged slice images, an enhancement is applied to the candidate findings, which enhancement is visible in the synthetic viewing image. The enhancement comprises at least one of the group of edge enhancement, binary masking, local de-noising, background noise reduction, change of signal attenuation value, and other image processing or marking methods.

According to an exemplary embodiment of the invention, the identification of the candidate findings in step b) is performed i) in space in the 3D volume data; and/or ii) in slice images generated from the 3D volume data.

For example, the object is a part of the human body.

According to an exemplary embodiment of the invention, the object is a female breast, and the synthetic viewing image comprises a synthetic mammogram.

According to an exemplary embodiment of the invention, the identification of candidate findings in step b) is based on computer assisted visualization and analysis for identification of candidate findings; and/or manual identification of candidate findings.

In another example, the object is a chest or gastric area of a patient.

According to an exemplary embodiment of the invention, the 3D volume data is reconstructed from a sequence of X-ray images from different directions of an object.

According to an exemplary embodiment of the invention, the method further comprises:

f) selecting a portion of the 3D volume;
g) re-computing the synthetic 2D projection, wherein enhancements of the related candidate findings in the selected portion are made visible; and
h) updating the presentation of the synthetic viewing image.

According to an exemplary embodiment of the invention, the method further comprises selecting a candidate finding in the synthetic 2D projection; and performing a secondary action upon the selection. The secondary action comprises presenting the tagged slice images comprising the selected candidate finding.

According to an aspect of the invention, a simplified 2D holistic view of a spatial object is provided to medical personnel in order to facilitate the process of obtaining a (first) basic overview of an examined object, in particular a female breast. This is particular the case for medical staff used to work with mammograms generated by X-ray machines. The invention aims to combine or enrich the “classic mammogram view” with additional information, such as candidate findings and their position information within the 3D volume. Although the synthetic mammogram shows the spatial content of the 3D data only as projection image in a 2D plane, i.e. the image plane of the mammogram, the respective spatial data of the findings is nevertheless still present and contained in the slice image as part of the 3D volume data, which is correlated with the 2D synthetic mammogram by additional position information assigned to each finding. Thus, the synthetic viewing image shown as a 2D image is a 2D⁺ image. Furthermore, the invention allows an interactive selection of objects of interest, for instance calcifications or lesions, within the classic mammogram view. The selection can then trigger a separate display or view to jump into a more detailed corresponding view, for example the particular slice image view, to show the related tissue in more detail. The invention allows the doctor to see all relevant and important information regarding the examined object in one place in a familiar image view. The present invention is in particular useful for mammography and also for chest or abdominal examination procedures.

### BRIEF DESCRIPTION OF THE DRAWINGS

Exemplary embodiments of the invention will be described in the following with reference to the following drawings.

FIG. 1 schematically illustrates an imaging arrangement according to an exemplary embodiment of the present invention.

FIG. 2 schematically illustrates an apparatus for presenting image information of an object according to an exemplary embodiment of the present invention.

FIG. 3 schematically shows a graphical user interface for providing image information of an object according to an exemplary embodiment of the present invention.

FIG. 4 shows basic steps of a method for providing image information of an object according to an exemplary embodiment of the present invention.

FIG. 5 shows another example of a method according to the present invention.

FIG. 6 shows an example of the method according to the present invention with a selection and enhancement of candidate findings.

FIG. 7 shows an example for the application of enhancements according to the present invention.

FIG. 8 shows an example of the method according to the present invention with selection and triggering of a secondary action.

FIG. 9 shows an example of the method according to the present invention relating to the identification of candidate findings.

FIG. 10 shows an example for displaying a related tagged slice image according to the present invention in a graphical presentation.

### DETAILED DESCRIPTION OF EMBODIMENTS

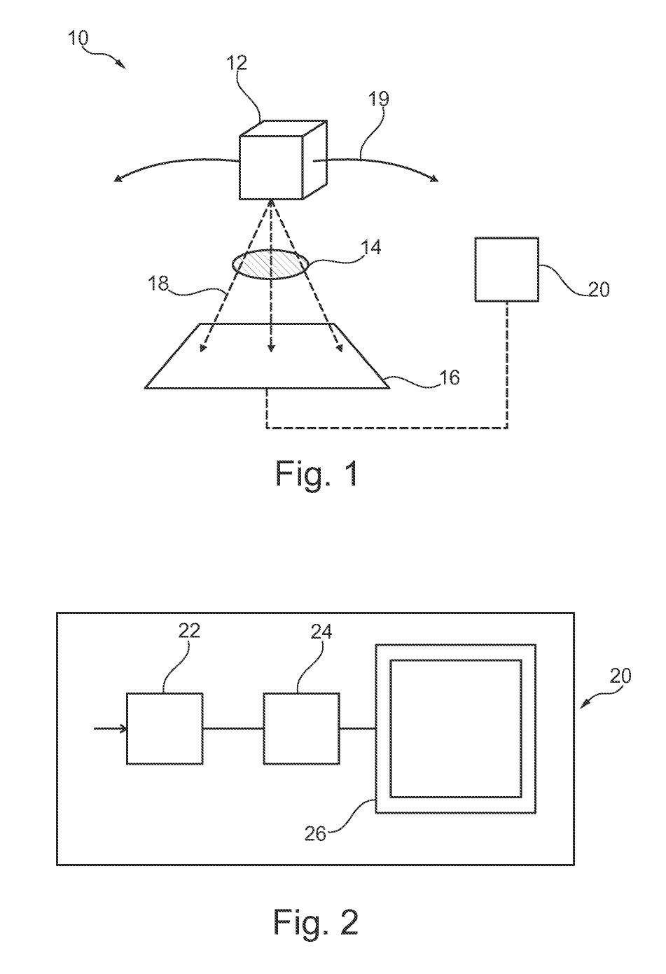

FIG. 1 describes an imaging system 10 for generation of image information of an object. For example, X-ray is used, but the system 10 can also comprise any other imaging technology comprising a preferred imaging direction, or a preferred projection direction. The system 10 comprises an X-ray source 12, an object 14 and a detector 16. The X-ray source generates X-ray radiation 18, with which the object 14 is radiated. In order to allow a reconstruction of a three dimensional (3D) projection of the object 14, the X-ray source 12 is movable within a certain range allowing multiple projections from different angles covering at least a sub-volume (region of interest) of the object. This is indicated with movement indicators 19. X-ray received by the detector 16 leads to the generation and transmission of projection signals and projection data. This projection data is transferred from the detector 16 to an apparatus 20 for providing image information of an object, as described further below.

FIG. 2 shows a schematic assembly of the apparatus 20 for providing image information of an object according to the present invention. The apparatus comprises a data input unit 22, a processing unit 24 and a presentation unit 26. The data input unit 22 provides the (raw) image data generated by the imaging system 10 described in FIG. 1. The processing unit 24 is adapted to perform calculations such as the reconstruction of the 3D volume out of the projection data of the imaging system or identification of the candidate findings (see also below in relation with the description of a method according to the present invention). The presentation unit 26 is adapted to present the results and information to a user. In most cases this can be a graphical monitor based on TFT or LCD technology or other devices such as lamp based projectors for usage in rooms, head-up displays on screens or 3D glasses.

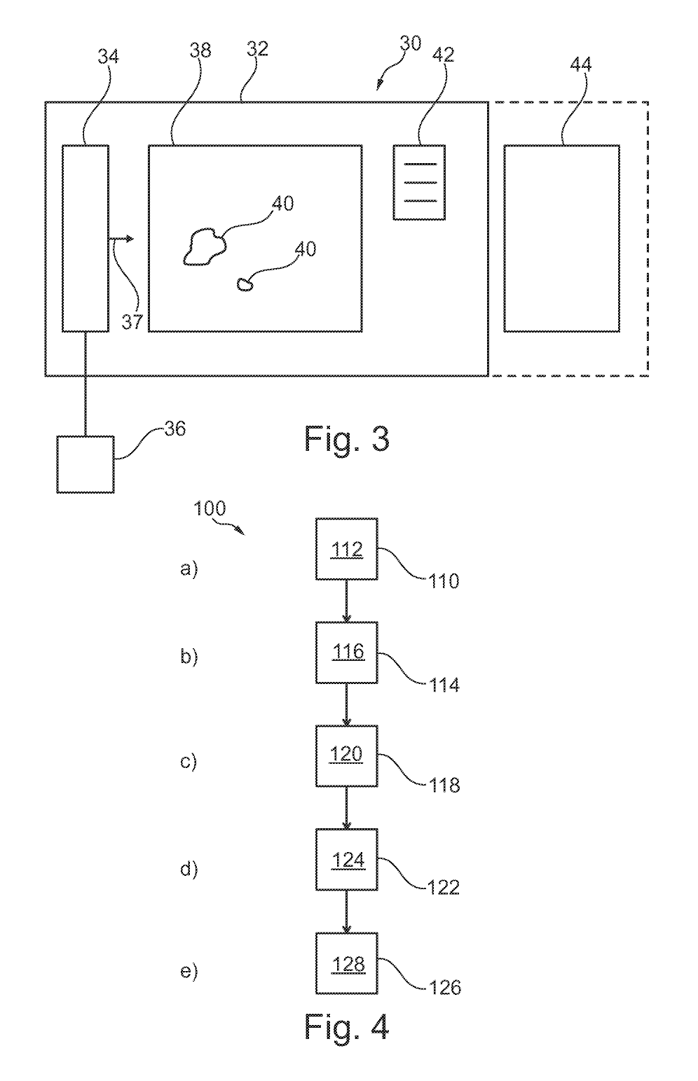

FIG. 3 shows a schematic view of a graphical user interface 30 for providing image information of an object comprising a display unit 32, a graphical user interface controller 34, and an input device 36. The display unit 32 presents a synthetic viewing image 38, comprising a plurality of interrelated image elements 40, and spatial information 42. The synthetic viewing image 38 is based on a synthetic 2D projection generated by a forward projection of at least a portion of at least some of a plurality of tagged slice images of 3D volume data of an object. The tagged slice images comprise identified candidate findings and a tag with spatial information of the respective candidate finding within the 3D volume. The interrelated image elements 40 are linked to the identified candidate findings by the spatial information. The input device 36 is provided for selecting at least one of the interrelated image elements 40 in the synthetic viewing image 38 presented by the display unit 32. Hence, the input device 36 provides the possibility to interact with the apparatus to perform actions like selecting elements, and, for example, also to navigate through or within views, zoom, switch views and others. The graphical user interface controller 34 is connected to the input device 36 and provides control signals, indicated with arrow 37, to several elements of the display unit 32. The spatial information 42 may show position data and other additional information related to the selected candidate finding. The graphical user interface 30 can further comprise a second display or display section 44 that is configured to show the related tagged slice image depending on the selected interrelated element 40 in the synthetic viewing image. This provides a simultaneous view of both the overview, i.e. the synthetic viewing image 38 as well as the detailed slice view (not further shown). However, the additional display section is optional and thus indicated with dotted lines. The display elements of the display unit 32 described above, in particular the synthetic viewing image 38, the spatial information 42 and the second display section 44, are controlled 37 by the graphical user interface controller 34. For simplicity, only one arrow is shown, indicated with reference number 37. Of course other links from the interface controller 34 to the other components or elements are also provided.

FIG. 4 shows an example of a method 100 for providing image information of an object according to the present invention.

In a first step 110, 3D data 112 of an object is provided. This data derives from the imaging system, for instance an X-ray machine.

Based on this 3D volume data, in an identification or second step 114, candidate findings 116 are identified within this 3D volume data 112. This identification can be performed either manually or based on a computer assisted method, or based on a combination of both computer assisted and manual identification methods. The computer assisted visualization and analysis is a method that uses predefined algorithms and rules to find spatial segments comprising irregularities or abnormal tissue structures. The manual identification is based on a specialist's assessment and selection decision, which may be based on his individual knowledge, experience and assessment. The automated computer based methods may be combined with a manual identification to support a high quality and accuracy of the identification of candidate findings.

The term “candidate finding” refers to a possible medical finding such as a lesion, a cyst, a spiculated mass lesion, an asymmetry, a calcification, a cluster of (micro-) calcifications, an architectural distortion, a ductual carcinoma in situ (DCIS), an invasive carcinoma, a nodule, a bifurcation, a rupture or fracture. The term “candidate” expresses in particular the fact that this identified finding is subject to further examination and assessment.

The candidate findings can be classified based on different criteria such as kind of finding, size, position and others. Such a classification can be used for instance in the presentation stage to present only selected groups of findings or apply different filters. Furthermore, a category selective enhancement can be applied such as colouring, highlighting, et cetera.

The spatial position information may comprise the representation of the location of the candidate finding within the 3D volume data. The spatial information comprises data to allow a determination of the location of the candidate finding within the 3D volume and/or the shape and size of a candidate finding. This information can be stored along with the candidate finding in a tag as a data record or as data in a data base. The tag is adapted to store information related to the candidate finding. The spatial position information of the candidate findings can be stored along with the 3D volume data and/or with the 2D image data.

In a third step 118, a plurality of tagged slice images 120 are created from the 3D volume data. The term “tagged slice image” relates to a complete slice or portions of a slice depending of the region of interest (ROI). The term “region of interest” relates to one or many areas in a 2D image or 3D volume that is of interest in terms of the purpose of the imaging. Taking only a portion out of a whole slice provides a possibility to focus on those specific regions of interest that require attention and more detailed examination. Thus, a portion relates to a partial segment of the image depending on the region of interest (ROI). A tagged slice image also refers to a two dimensional (2D) image that represents a defined portion of the 3D volume. The image information of the slice image is combined with the candidate findings identified in the previous step. For each slice image only those candidate findings are considered that have been identified in that corresponding portion of the 3D volume. In addition, spatial information of each candidate finding is added to the slice image. The spatial information can be position information of the related candidate finding within the 3D volume. This information is provided in a tag. A tag can be a record in a database or any other method to link the candidate finding to the set of spatial information of that candidate finding. The advantage of providing spatial information along with the related candidate finding is the possibility to allow processing of position information in any of the next steps.

In a fourth step 122, a synthetic 2D projection 124 is computed by a forward projection. A synthetic 2D projection can be seen as image data resulting from a forward projection. The forward projection can be performed either based on the entire set of tagged slices or based on a subset or part of the set of tagged slice images. For example, a forward projection is a method to generate a 2D image out of a 3D volume, wherein, originating from an infinitesimal small point, all points are approached along the respective projection axis towards the (virtual) detector plane. A value is determined based on the forward projection method selected. Examples for computing synthetic 2D projections by forward projection may comprise: a maximum intensity projection (MIP), a weighted averaging of intensity values along the projection direction, a nonlinear combination of intensity values along the projection direction. The synthetic 2D projection is computed in the native acquisition geometry or any approximations thereof, for example in a cone-beam X-ray acquisition, the forward projected 2d synthetic image can be computed with a ray-driven algorithm by evaluating the intersection of each X-ray line, defined by the X-ray focus and a 2D pixel position in the 2D synthetic projection image, with the 3D voxel grid of the 3D volumetric data. In a cone-beam X-ray acquisition, the forward projected synthetic 2D projection can also be computed in an approximate parallel geometry by averaging all voxels in the 3D volume data along direction x, y or z.

In a fifth step 126, the synthetic 2D projection 124 is presented to a user as a synthetic viewing image 128. A synthetic viewing image is the graphical representation (for instance on a screen) of the synthetic 2D projection generated in a previous step. The synthetic viewing image 128 comprises the candidate findings of the projected tagged slice images. In this synthetic viewing image 128, the candidate findings are shown as selectable elements, i.e. the user can point, click or select in any other way the candidate finding within the synthetic viewing image.

The first step 110 is also referred to as step a), the second step 114 as step b), the third step 118 as step c), the fourth step 122 as step d), and the fifth step 126 as step e).

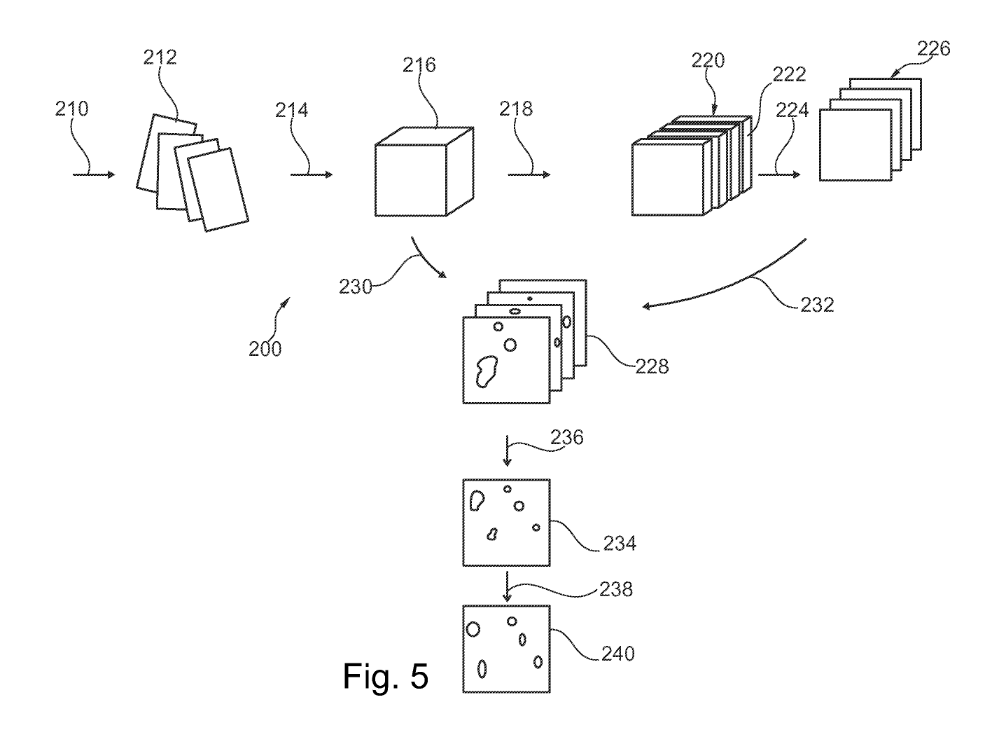

FIG. 5 describes a further example of a method 200 for providing image information of an object. First, the imaging system acquires 210 a sequence of projection images 212, using for instance a tomosynthesis apparatus. In a next step 214, a 3D volume 216 is reconstructed based on the sequence of projection images 212. This so-to-speak 3D space is then partitioned 218 in a further step into portions 220 of the 3D space. These portions 220 each represent a 3D sub volume 222 of the whole reconstructed 3D volume 216. In a next step, the partitions 220 of the 3D volume are projected 224 into slice images 226 that comprise image information of the related portion of the 3D volume. In the following step, tagged slice images 228 are generated using either candidate findings identification methods applied 230 to the 3D volume 216, and/or identification methods applied 232 to the 2D slice images 226. The resulting candidate findings as well as the related spatial information of the candidate findings are added to the slice images 226, which is why the term “tagged slice images” is used. A specific tagged slice image comprises only identified candidate findings of the related slice image in addition to the image data of the slice. A synthetic 2D projection 234 is generated in a further step by a forward projection 236 of all or parts of the tagged slice images. Next, the synthetic 2D projection 234 is presented 238 as a synthetic viewing image 240 in a next step.

As indicated above, the 3D volume data is reconstructed from data acquired of a 3D object. The data may also be acquired by magnetic resonance imaging technology or by ultrasound technology. In a further example, the data is acquired by X-ray technology. Hence, as mentioned above, the imaging technology relates to all imaging technologies comprising a preferred image/projection direction.

For reconstructing the 3D volume data, a sequence of X-ray images is used acquired as X-ray tomosynthesis. The sequence of X-ray images may also be generated by computer tomography (CT).

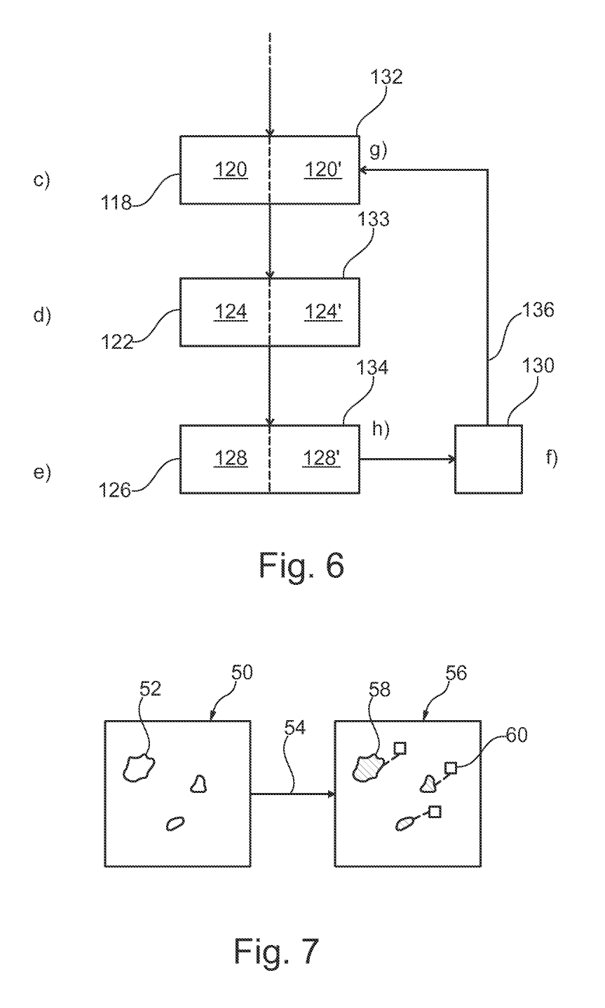

FIG. 6 describes the application of enhancement of candidate findings depending on the selected portion of the 3D space. The initial steps, and in particular the step c) of the generating 118 of the tagged slice images 120, the step d) of the computing 122 of the synthetic 2D projection 124, and step e) of the presenting 126 of the synthetic viewing image 128, as also part of the method shown in FIG. 6, have been described in FIG. 4.

As shown in FIG. 6, the user selects 130 a portion of the 3D volume using the user input device as described above. This can be, for example, a graphical section of a display that allows the user to point to a specific region or section of the 3D volume or to one or several specific candidate findings.

The selection of the spatial section can be seen as independent from any candidate findings. Purpose of this method is to allow a user controlled spatial scrolling sequentially slice per slice along a projection axis through the 3D object.

Another selection option is to choose a subset of candidate findings from a list of all candidate findings shown in a separate section of the display. In addition, specific filters (for instance limitation to calcifications) can be applied. A list view can also allow the user to sequentially scroll through the list of candidate findings, for instance using the mouse wheel.

Depending on the chosen selection 130, for example according to one of the before mentioned embodiments, a re-computing 132 of a tagged slice image 120′, or several tagged slice images, is performed, wherein an enhancement is applied to the related candidate findings.

Since the re-computing step 132, and also the following steps, are basically similar to the basic method steps as described in relation with FIG. 4, the respective steps of the loop-like arrangement of FIG. 6 could also be referred to with same reference numbers added by an apostrophe.

In a next step, the tagged slice image 120′ is forward projected 133 leading to a synthetic 2D projection 124′, and enhancements of the related candidate findings in the selected portion are made visible.

This re-calculated synthetic 2D projection is then displayed by an updating 134 of the presentation of the synthetic viewing image 128 resulting in a synthetic viewing image 128′.

The selecting 130 is also referred to as step f), the re-computing 132 as step g) and the updating 134 as step h).

The selection with re-computing and updating can be provided in a loop like manner as indicated with arrow 136.

For example, only the enhancements of the related candidate findings in the selected portion are made visible in the synthetic 2D projection. Thus, in one example, a synthetic 2D projection can comprise enhancements of candidate findings of only that particular tagged slice image or can, in addition, also comprise enhancements of candidate findings in other tagged slice images. For example, in step g), enhancements of candidate findings outside the selected portion are blanked on the respective tagged slice image, i.e. they are not visible on the respective tagged slice images.

The selection of the slice image may be performed by a user, for example, the selection of the portion is performed by using a graphical user interface.

In FIG. 7, an example of an enhancement is shown. An image 50, showing the synthetic viewing image 38, for example, comprises several candidate findings 52 that have been identified in a previous step. An enhancement 54 of the candidate findings is applied to the tagged slice images aiming to visually separate the candidate findings from the surrounding image texture. As a result, an enhanced image 56 is shown with enhanced candidate findings 58. This supports the radiologist in detecting the candidate findings in an image in an easier and faster way, because in the original image the findings may not be clearly visible or hidden in the texture of the image as shown in the enhanced image 56. Enhancing can be achieved with any image processing or marking methods like edge enhancement, binary masking, local de-noising, background noise reduction, change of signal attenuation value. The parameters of the enhancements can be stored along with other data in tags 60 assigned to the candidate finding.

The enhancement relates to a visual separation of the candidate findings from the surrounding image texture.

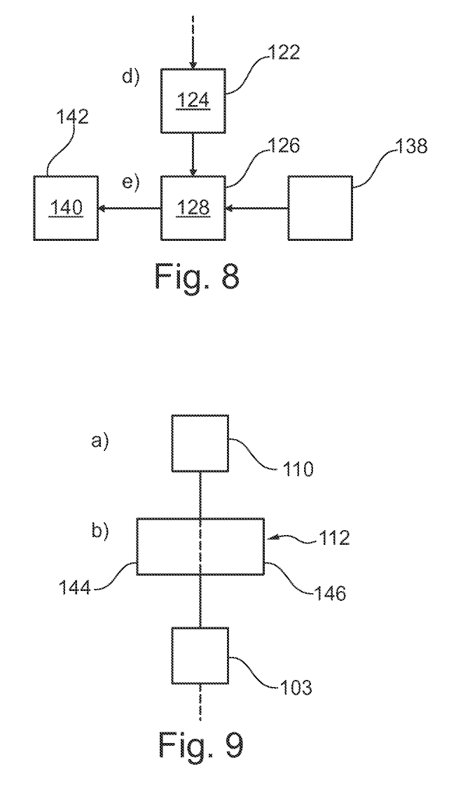

FIG. 8 shows a further example of the method in which a candidate finding is selected 138 in the presented synthetic viewing image 128 and a secondary action 140 is triggered 142. The synthetic viewing image 128 has been calculated in the previous steps, which have been described above in relation with FIG. 4. For example, the secondary action 140 may comprise presenting the tagged slice images comprising the selected candidate finding to the corresponding slice image as a further image in addition to the synthetic viewing image. For example, this allows the user to jump to the related tagged slice image view of the selected candidate finding.

For example (not shown), as a secondary action, the tagged slice image(s) is (are) presented separately.

FIG. 9 describes two methods to identify candidate findings. The first step 110 has been described in FIG. 4 and relates to providing the 3D volume data of an object. The following identification 112 of the candidate findings located in the 3D volume data can be performed as a first identification 144 in 2D space, e.g. in slice images, and, parallel in addition or alternatively, as a second identification 146 in 3D volume, e.g. in the 3D data 112.

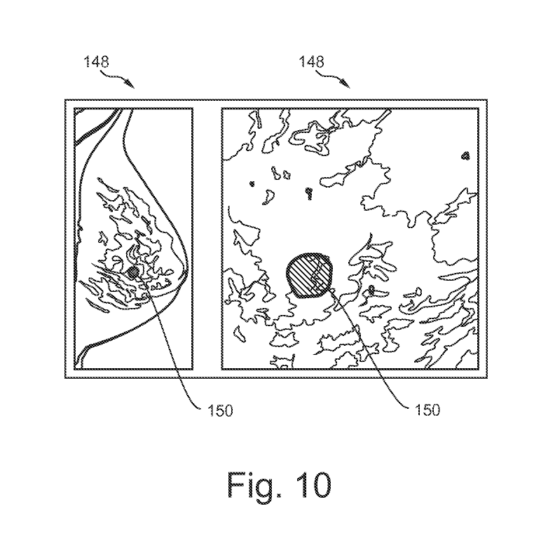

FIG. 10 shows a drawing of an example of a synthetic 2D projection. As can be seen, a synthetic mammogram 148 is shown together with enhanced findings 150. A synthetic mammogram is a computed 2D image based on 3D volume data which graphical representation is similar to the classic mammogram view. The left side of the image 148 shows an overview of a breast with the enhanced candidate findings 150. On the right side a related detailed view allows to see certain selected areas in more detail, for instance by zooming, also showing the candidate findings 150. FIG. 10 represents a simplified and schematic view of a typical photo-like greyscale or colour image (not shown here) presented to the radiologist. Through the detailed photographic presentation the detailed tissue structure of the candidate findings 150 and the surrounding area of the examined object become visible. These images can be based on typical greyscale or colour display modes, e.g. 32 bit True Colour mode, as used in many display systems. The enhancement clearly separates the candidate findings 150 from the surrounding tissue while showing a much higher degree of details in the actually presented photographic image 148. In this particular example the enhanced candidate findings 150 are shown in higher contrast and higher brightness compared to the surrounding texture. These enhancements that are mostly based on image processing methods make it is easier to instantly identify such candidate findings 150 in an image 148 by a radiologist.

In another exemplary embodiment of the present invention, a computer program or a computer program element is provided that is characterized by being adapted to execute the method steps of the method according to one of the preceding embodiments, on an appropriate system.

The computer program element might therefore be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. An apparatus for providing medical image information of an object, the apparatus comprising:
an data input unit;
a processing unit; and
a presentation unit;
wherein the data input unit is configured to provide 3D volume data of an object;
wherein the processing unit is configured to identify candidate findings located in the 3D volume data, wherein the processing unit is configured to assign spatial position information of the candidate findings to the respective identified candidate finding; and to generate a plurality of tagged slice images of the 3D volume data, wherein each tagged slice image relates to a respective portion of the 3D volume data, wherein the tagged slice images comprise those candidate findings identified in the respective portion and a tag with the spatial information of the respective candidate finding within the 3D volume; and to compute a synthetic 2D projection by a forward projection of the plurality of tagged slice images, wherein the synthetic 2D projection comprises a projection of the candidate findings, and wherein the spatial position information is assigned to the projection of the candidate finding; and
wherein the presentation unit is configured to present the synthetic 2D projection as a synthetic viewing image to a user, wherein the candidate findings are selectable elements within the synthetic viewing image.

2. The apparatus according to claim 1, wherein the processing unit is further configured to enhance the candidate findings for the generation of the tagged slice images, which enhancement is visible in the synthetic viewing image.

3. A graphical user interface for providing medical image information of an object, the graphical user interface comprises:
a display unit;
a graphical user interface controller; and
an input device;
wherein the display unit is configured to present a synthetic viewing image based on a synthetic 2D projection generated by a forward projection of at least a portion of at least some of a plurality of tagged slice images of 3D volume data of an object; wherein the tagged slice images comprise identified candidate findings and a tag with spatial information of the respective candidate finding within the 3D volume; and wherein the synthetic viewing image comprises a plurality of interrelated image elements linked to the identified candidate findings;
wherein the input device is provided for selecting at least one of the interrelated image elements in the synthetic viewing image presented by the display unit;
wherein the graphical user interface controller is configured to provide control signals to the display unit to display spatial information in relation with the at least one selected interrelated image element; and
wherein the display unit is configured to update the spatial information depending on the selection of the interrelated image elements.

4. Graphical user interface according to claim 3, wherein the graphical user interface controller is configured to determine at least one of the tagged slice images, in which the candidate finding is located that is linked to the selected at least one interrelated image element; and
wherein the display unit is configured to display the determined at least one tagged slice image in addition to the synthetic viewing image.

5. A method for providing medical image information of an object, the method comprising the following steps:
a) providing 3D volume data of an object;
b) identifying candidate findings located in the 3D volume data;
wherein spatial position information of the candidate findings is assigned to the respective identified candidate finding;
c) generating a plurality of tagged slice images of the 3D volume data;
wherein each tagged slice image relates to a respective portion of the 3D volume data; and
wherein the tagged slice images comprise those candidate findings identified in the respective portion and a tag with the spatial information of the respective candidate finding within the 3D volume;
d) computing a synthetic 2D projection by a forward projection of at least a portion of at least a number of the plurality of tagged slice images;
wherein the synthetic 2D projection comprises a projection of the candidate findings; and
wherein the spatial position information is assigned to the projection of the candidate finding; and
e) presenting the synthetic 2D projection as a synthetic viewing image to a user;
wherein the candidate findings are selectable elements within the synthetic viewing image.

6. The method according to claim 5, wherein the synthetic 2D projection is computed by a forward projection of at least a portion of each of the plurality of tagged slice images.

7. The method according to claim 5, wherein, for the generation of the tagged slice images, an enhancement is applied to the candidate findings, which enhancement is visible in the synthetic viewing image;
wherein the enhancement comprises at least one of the group of:
edge enhancement;
binary masking;
local de-noising;
background noise reduction;
change of signal attenuation value; and
other image processing or marking methods.

8. The method according to claim 5, wherein the identification of the candidate findings in step b) is performed:
i) in space in the 3D volume data; and/or
ii) in slice images generated from the 3D volume data.

9. The method according to claim 5, wherein the object is a female breast; and wherein the synthetic viewing image comprises a synthetic mammogram.

10. The method according to claim 5, wherein the identification of candidate findings in step b) is based on:
computer assisted visualization and analysis for identification of candidate findings; and/or
manual identification of candidate findings.

11. The method according to claim 5, wherein the 3D volume data is reconstructed from a sequence of X-ray images from different directions of an object.

12. The according to claim 5, further comprising the following steps:
f) selecting a portion of the 3D volume;
g) re-computing the synthetic 2D projection, wherein enhancements of the related candidate findings in the selected portion are made visible; and
h) updating the presentation of the synthetic viewing image.

13. The method according to claim 5, further comprising the following steps:
selecting a candidate finding in the synthetic viewing image; and
performing a secondary action upon the selection;
wherein the secondary action comprises presenting the tagged slice images comprising the selected candidate finding.

14. A Computer program element for controlling an apparatus according to claim 1, which, when being executed by a processing unit, is adapted to perform the method steps of:
a) providing 3D volume data of an object;
b) identifying candidate findings located in the 3D volume data;
wherein spatial position information of the candidate findings is assigned to the respective identified candidate finding;
c) generating a plurality of tagged slice images of the 3D volume data; wherein each tagged slice image relates to a respective portion of the 3D volume data; and wherein the tagged slice images comprise those candidate findings identified in the respective portion and a tag with the spatial information of the respective candidate finding within the 3D volume;
d) computing a synthetic 2D projection by a forward projection of at least a portion of at least a number of the plurality of tagged slice images; wherein the synthetic 2D projection comprises a projection of the candidate findings; and wherein the spatial position information is assigned to the projection of the candidate finding; and
e) presenting the synthetic 2D projection as a synthetic viewing image to a user:
wherein the candidate findings are selectable elements within the synthetic viewing image.

15. Computer readable medium having stored the program element of claim 14.
